(19) United States
(12) Patent Application Publication
(10) Pub. No.: US 2026/0024711 A1
(43) Pub. Date: Jan. 22, 2026

(54) SWITCH SYSTEM

(71) Applicants: TOYOTA JIDOSHA KABUSHIKI KAISHA, Aichi-ken (JP); DENSO CORPORATION, Aichi-pref (JP)

(72) Inventors: Hiroto MARUYAMA, Toyota-shi (JP); Mitsuyo OMURA, Kariya-city (JP)

(21) Appl. No.: 19/264,867

(22) Filed: Jul. 10, 2025

(30) Foreign Application Priority Data
Jul. 18, 2024 (JP) 2024-114990

(51) Int. Cl. H01H 9/54; H01H 9/00

(52) U.S. Cl. CPC H01H 9/547; H01H 9/0066; H01H 2009/0083; H01H 2231/016; H01H 2231/026; H01H 2300/052

(57) ABSTRACT

In a switch system including a set temperature UP switch that raises a set temperature of an air conditioner unit and a set temperature DOWN switch that lowers the set temperature, when a stuck-ON determination unit determines that only the set temperature UP switch is in a stuck-ON state, a stuck-ON recognition unit also sets the set temperature DOWN switch as being in a stuck-ON state. This makes it possible to eliminate a malfunction caused by only one of the switches becoming stuck ON.

### CROSS-REFERENCE TO RELATED APPLICATION

This application claims priority to Japanese Patent Application No. 2024-114990 filed on Jul. 18, 2024. The disclosure of the above-identified application, including the specification, drawings, and claims, is incorporated by reference herein in its entirety.

### BACKGROUND

### 1. Technical Field

The disclosure relates to a switch system including a switch for operating an in-vehicle device or the like. In particular, the disclosure relates to control in a case in which the switch is in a stuck-ON state.

### 2. Description of Related Art

Typically, various switches typified by a switch for operating an air conditioner are installed inside a vehicle cabin of a vehicle. As this type of switch, for example, a switch that outputs an ON signal when operated to be pushed in and outputs an OFF signal when the push-in operation is released is known.

However, the ON signal from the switch that has been operated (pushed-in) may be continuously output even after the operation is released, that is, a stuck-ON state may occur. Such a stuck-ON state may occur not only in a physical switch (a switch that is moved by mechanical push-in operation), but also in a touch panel switch.

Examples of the cause of the stuck-ON state of a switch in the case of a physical switch include a case in which, when the switch is pushed in, the switch gets caught in another member (such as a frame surrounding the switch) and cannot return to its original position, and a case in which, when liquid (such as a drink) is spilled around the switch, and the moisture in the liquid evaporates and liquid having viscosity remains, the switch (the switch that has been pushed in) cannot return to its original position due to the viscosity. In addition, an example of the cause of the stuck-ON state in both a physical switch and a touch panel switch is a case in which the switch is kept in an ON-state due to an electrical malfunction inside the switch.

When the switch becomes stuck ON, it is necessary to perform a stuck-ON determination in response thereto. In Japanese Unexamined Patent Application Publication No. 2018-144709 (JP 2018-144709 A), when a switch continuously outputs an ON signal for a predetermined time, it is determined that the switch is in a stuck-ON state, the fact that the switch is in the stuck-ON state is stored, and control is performed to disable a holding-down operation on the switch after that (even when the switch outputs an ON-signal, the ON signal is made ineffective).

### SUMMARY

As examples of types of switches, there are switches for providing different control instructions to the same control target. Examples of these switches include a set temperature UP switch and a set temperature DOWN switch on an air conditioner operation panel. In this case, the control target is, for example, a heat pump (e.g., a compressor and an expansion valve). Other examples of the switches for providing different control instructions to the same control target include an air volume increase switch and an air volume decrease switch on the air conditioner operation panel. In this case, the control target is a fan.

Only one of the switches for providing different control instructions to the same control target may become stuck ON. In this case, when operation of the switch in the stuck-ON state is disabled as in JP 2018-144709 A, since the other one of the switches can be operated, only control to one side provided by operation of the operable switch is enabled, which may cause a situation in which the control of the control target cannot be returned to the other side. For example, when the set temperature UP switch becomes stuck ON, an occupant may operate the set temperature DOWN switch to check the operation of the air conditioner because operation of the set temperature UP switch is disabled. However, in this case, since the set temperature can be lowered, but the set temperature cannot be raised, such a malfunction that the temperature in the vehicle cabin becomes too low may be caused. In particular, in a case in which the set temperature is shifted to a default set value (e.g., 25° C.) when one of the set temperature UP switch and the set temperature DOWN switch becomes stuck ON, this malfunction is particularly noticeable when the set temperature UP switch or the set temperature DOWN switch has become stuck ON and the set temperature has been shifted to the default set value.

The present disclosure has been made in view of the above point, and an object thereof is to provide a switch system that can eliminate the malfunction that occurs when one of the switches for providing different control instructions to the same control target becomes stuck ON.

The solution to achieve the above object of the present disclosure is a switch system including a first switch that provides a control instruction to a control target by being operated, and a second switch that provides a control instruction different from the control instruction from the first switch to the control target by being operated. In the switch system, when determination is made that only one of the first switch and the second switch is in a stuck-ON state, and operation of the switch in the stuck-ON state is disabled, the other one of the first switch and the second switch is also set as being in a stuck-ON state.

The technical category of the control instruction of the first switch the control instruction of the second switch being different from each other is not limited to a case in which the detail of the control instruction of the first switch (e.g., the direction of control) and the detail of the control instruction of the second switch (e.g., the direction of control) are opposite (the directions of control are opposite directions) (e.g., a case in which, in an air conditioner, the first switch is a set temperature UP switch and the second switch is a set temperature DOWN switch), but also includes a case of different control modes (e.g., a case in which an air conditioner includes a plurality of switches that switches an outlet for air-conditioning air, and a mode for blowing the air-conditioning air is switched in accordance with the operated switch).

When determination is made that only one of the first switch and the second switch is in a stuck-ON state and operation on the switch in the stuck-ON state is disabled, if operation on the other one of the switches is enabled, a return from control corresponding to the operation on the other one of the switches to control corresponding to the operation on the one of the switches cannot be made. In view of this point, in the solution, in such a situation, the other one of the switches is also set as being in a stuck-ON state, thereby eliminating the malfunction caused by only the one of the switches being in the stuck-ON state.

In addition, when determination is made that the stuck-ON state of the one of the first switch and the second switch determined to be in the stuck-ON state is resolved, the setting of the other one of the first switch and the second switch as being in the stuck-ON state may be canceled.

Accordingly, in response to the resolution of the stuck-ON state of the one of the switches, the operation of both the first switch and the second switch is enabled, and it is possible to return the switch system to its normal operation.

In addition, the first switch and the second switch may indicate directions of control in the control target, and the direction of the control instruction from the first switch and the direction of the control instruction from the second switch may be opposite to each other.

In the case of such switches, when only one of the switches becomes stuck ON and its operation is disabled, and only control on the control target to one side performed by operation on the other one of the switches is enabled as in the related art, a situation in which the control on the control target cannot be returned to the other side may be caused. In the present disclosure, as described above, when it is determined that only one of the switches is in a stuck-ON state and operation of the switch in the stuck-ON state is disabled, the other one of the switches is also set as being in a stuck-ON state, which prevents a situation in which only control to one side is enabled. Thus, it is possible to solve problems in the related art in this type of switch.

In addition, the switch system may further include a third switch that selectively provides control instructions in both the direction of the control in the control target when the first switch is operated and the direction of the control in the control target when the second switch is operated. When determination is made that only one of the first switch and the second switch is in a stuck-ON state, and operation of the switch in the stuck-ON state is disabled, the other one of the first switch and the second switch may also be set as being in a stuck-ON state, whereas operation of the third switch may be enabled without setting the third switch as being in a stuck-ON state.

When it is determined that only one of the first switch and the second switch is in a stuck-ON state, and the operation of these switches is disabled, control instructions cannot be provided to the control target by operating these switches. However, when the third switch that can selectively provide control instructions in both directions for control on the control target is provided, the third switch is not set as being in a stuck-ON state. That is, the operation of the third switch is enabled. Accordingly, even when one of the first switch and the second switch becomes stuck ON, it is possible to provide control instructions to one side and the other side for control on the control target and continuously control the control target.

In the present disclosure, when it is determined that only one of the first switch and the second switch is in a stuck-ON state and operation of the switch in the stuck-ON state is disabled, the other one of the switches is also set as being in a stuck-ON state. This makes it possible to eliminate the malfunction caused by only the one of the switches being in the stuck-ON state (the situation in which a return from control corresponding to the operation on the other one of the switches to control corresponding to the operation on the one of the switches cannot be made).

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing each switch of an air conditioner operation portion according to an embodiment;

FIG. 2 is a block diagram showing the schematic configuration of an air conditioner system according to the embodiment;

FIG. 3 is a flowchart showing the procedure for air-conditioning control in response to a switch operation in the embodiment;

FIG. 4A is a timing chart showing the relationship between a switch depression state and switch determination corresponding thereto in the embodiment;

FIG. 4B is a timing chart showing the relationship between the switch depression state and the switch determination corresponding thereto in the embodiment;

FIG. 4C is a timing chart showing the relationship between the switch depression state and the switch determination corresponding thereto in the embodiment;

FIG. 5A is a diagram showing a modification of an air volume setting switch;

FIG. 5B is a diagram showing a modification of the air volume setting switch;

FIG. 5C is a diagram showing a modification of the air volume setting switch;

FIG. 5D is a diagram showing a modification of the air volume setting switch;

FIG. 5E is a diagram showing a modification of the air volume setting switch;

FIG. 6A is a diagram showing a modification of a set temperature change switch;

FIG. 6B is a diagram showing a modification of the set temperature change switch;

FIG. 6C is a diagram showing a modification of the set temperature change switch;

FIG. 6D is a diagram showing a modification of the set temperature change switch; and

FIG. 6E is a diagram showing a modification of the set temperature change switch.

### DETAILED DESCRIPTION OF EMBODIMENTS

Hereinbelow, an embodiment of the present disclosure will be described based on the drawings. In the present embodiment, a case in which a switch system according to the present disclosure is applied to a switch system including a switch for operating an air conditioner of a battery electric vehicle will be described. In addition, in the present embodiment, an example in which the switch is a physical switch, and outputs an ON signal when operated to be depressed and outputs an OFF signal when the depression operation is released will be described. The switch system according to the present disclosure is applicable not only to a battery electric vehicle, but also to other vehicles (e.g., a conventional vehicle, a hybrid electric vehicle, a plug-in hybrid electric vehicle, and a fuel cell electric vehicle).

### Description for Air Conditioner Operation Portion

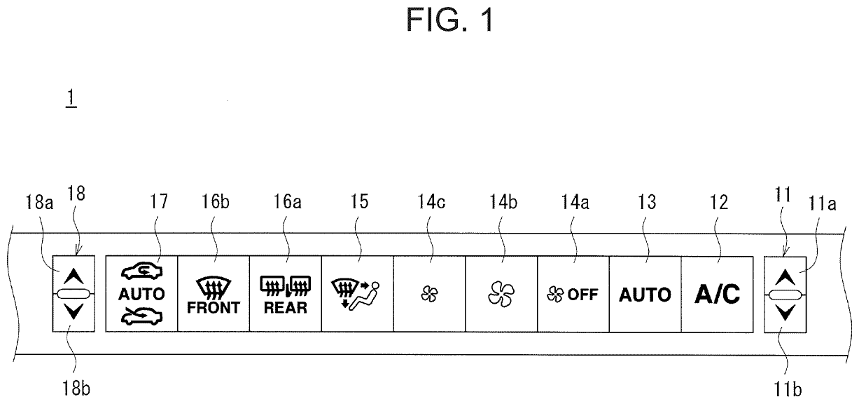

FIG. 1 is a diagram showing each switch of an air conditioner operation portion 1 according to the present embodiment. The air conditioner operation portion 1 is disposed on an instrument panel inside a vehicle cabin. When an occupant performs a depression (push-in) operation on the switch, an air conditioner ECU, which will be described further below, controls an air conditioner (air conditioner unit) in response to the operation.

As a plurality of switches provided on the air conditioner operation portion 1 shown in FIG. 1, a driver's seat side set temperature change switch 11, an air conditioner switch 12, an auto switch 13, an OFF switch 14a, an air volume increase switch (corresponding to the first switch in the present disclosure) 14b, an air volume decrease switch (corresponding to the second switch in the present disclosure) 14c, a blowoff mode switch 15, a rear window defogger switch (that also serves as a mirror heater switch) 16a, a front defroster switch 16b, an internal-external air selector switch 17, and a front passenger seat side set temperature change switch 18 are provided in this order from the right side of the drawing. In addition, the driver's seat side set temperature change switch 11 includes a set temperature UP switch (corresponding to the first switch in the present disclosure) 11a and a set temperature DOWN switch (corresponding to the second switch in the present disclosure) 11b, and the front passenger seat side set temperature change switch 18 includes a set temperature UP switch (corresponding to the first switch in the present disclosure) 18a and a set temperature DOWN switch (corresponding to the second switch in the present disclosure) 18b.

Since the operation of the air conditioner unit when the switches 11 to 18 are operated to be depressed (that is, operated to be pushed in the direction perpendicular to the paper in FIG. 1) is well known, the description thereof will be omitted. The various switches provided on the air conditioner operation portion 1 are not limited to those described above, and a synchronous switch for linking the driver's seat side set temperature and the front passenger seat side set temperature to each other, a direct instruction switch for directly indicating (controlling) each set temperature, or a relative instruction switch for raising or lowering the temperature inside the vehicle cabin from the current temperature may be provided. Examples of the direct instruction switch and the relative instruction switches will be described further below.

### Schematic Configuration of Air Conditioner System

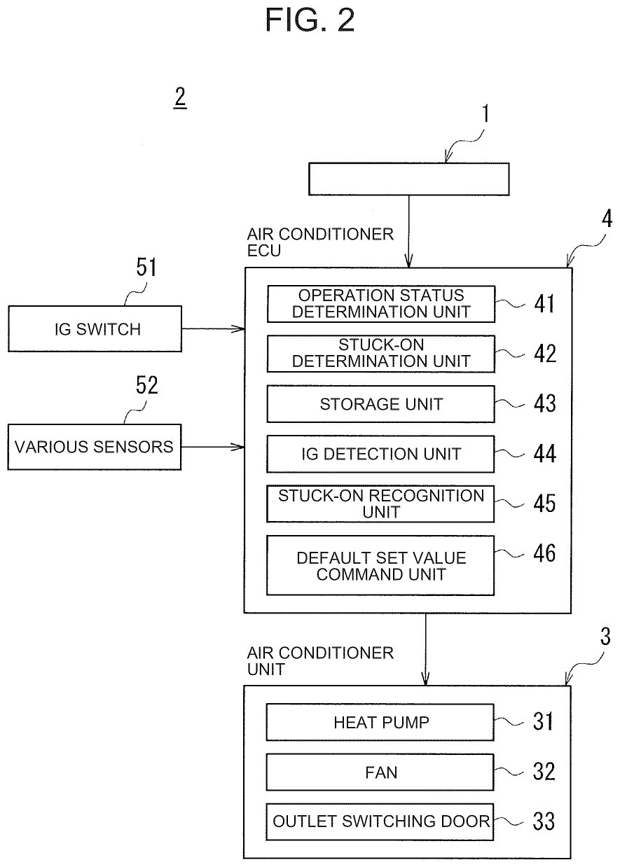

FIG. 2 is a block diagram showing the schematic configuration of an air conditioner system 2 according to the present embodiment. As shown in this FIG. 2, the air conditioner system 2 includes the air conditioner operation portion 1 including the switches 11 to 18 described above (refer to FIG. 1), an air conditioner unit 3, and an air conditioner ECU 4.

The air conditioner unit 3 is configured to blow air-conditioning air having an adjusted temperature and an adjusted humidity into the vehicle cabin through an outlet. The air conditioner unit 3 includes a heat pump 31, a fan 32, and an outlet switching door 33.

The heat pump 31 includes, for example, an electric compressor, an outdoor heat exchanger, an indoor heat exchanger, and an expansion valve, and is configured to form a refrigerant circulation path in response to an air-conditioning request in the vehicle cabin. The electric compressor is provided to circulate a refrigerant through the circulation path. The electric compressor is operated with electric power from a battery and configured to have a rotation speed adjustable by, for example, inverter control. In a conventional vehicle equipped with an engine, a compressor may be a mechanical compressor and operated by receiving power from the engine. The outdoor heat exchanger is disposed in a motor compartment, and the indoor heat exchanger is disposed in an air duct (not shown). The expansion valve decompresses the refrigerant circulated through the circulation path.

The fan 32 is configured to selectively draw in outside air and/or inside air and feed the drawn-in air to the air duct. The fan 32 is operated with electric power from the battery and configured to have an adjustable rotation speed.

In cooling operation, the outdoor heat exchanger functions as a condenser, and the indoor heat exchanger functions as an evaporator, thereby cooling the blown air in the indoor heat exchanger. In heating operation, the indoor heat exchanger functions as a condenser, and the outdoor heat exchanger functions as an evaporator, thereby heating the blown air in the indoor heat exchanger. A heating heat exchanger may be installed inside the air duct in addition to the indoor heat exchanger, and the blown air dehumidified in the indoor heat exchanger may be heated by the heating heat exchanger. In a conventional vehicle equipped with an engine, heating in the vehicle cabin is performed using the heat of an engine coolant.

A downstream end of the air duct has a plurality of outlets, and the outlet switching door 33 is provided at the outlets. The outlets include a face outlet through which the air-conditioning air is blown toward the upper body of an occupant in the vehicle cabin, a foot outlet through which the air-conditioning air is blown toward the feet of the occupant in the vehicle cabin, and a defroster outlet through which the air-conditioning air is blown toward the inner face of a windshield.

The air conditioner ECU 4 is provided to control the air conditioner unit 3. An ignition (IG) switch 51 and various sensors 52 are connected to the air conditioner ECU 4 through signal lines. This allows an ON signal (IG-ON signal) and an OFF signal (IG-OFF signal) from the IG switch 51 and sensing signals from the various sensors 52 to be input to the air conditioner ECU 4. Examples of the various sensors 52 include an in-cabin temperature sensor, an outside air temperature sensor, and a solar radiation sensor.

In addition, control programs for performing various types of control for the air conditioner unit 3 are stored in the air conditioner ECU 4 (more specifically, in a ROM of the air conditioner ECU 4).

The air conditioner ECU 4 includes, as its functional units, an operation status determination unit 41, a stuck-ON determination unit 42, a storage unit 43, an IG detection unit 44, a stuck-ON recognition unit 45, and a default set value command unit 46. Each of the functional units including the operation status determination unit 41, the stuck-ON determination unit 42, the IG detection unit 44, the stuck-ON recognition unit 45, and the default set value command unit 46 is implemented by the control program stored in the ROM of the air conditioner ECU 4. In addition, the storage unit 43 is implemented by a backup RAM (nonvolatile memory) that stores information even after IG-OFF.

The operation status determination unit 41 obtains a state signal when any one of the switches of the air conditioner operation portion 1 is operated. For example, when the set temperature UP switch 11a of the driver's seat side set temperature change switch 11 is operated to be depressed, an ON signal (the ON signal of the set temperature UP switch 11a) is input to the operation status determination unit 41 of the air conditioner ECU 4. In addition, when the depression operation on the set temperature UP switch 11a of the driver's seat side set temperature change switch 11 is released, an OFF signal (the OFF signal of the set temperature UP switch 11a) is input to the operation status determination unit 41 of the air conditioner ECU 4. Similarly, when another switch is operated to be depressed or the depression operation is released, an ON signal or an OFF signal of the switch is input to the operation status determination unit 41 of the air conditioner ECU 4.

When an ON signal (state signal) is continuously input to the operation status determination unit 41 from a certain switch, the stuck-ON determination unit 42 determines that the switch is in a stuck-ON state. For example, when an ON signal is continuously output from the set temperature UP switch 11a of the driver's seat side set temperature change switch 11 for a predetermined time (e.g., for 5 seconds), and the ON signal is continuously input to the operation status determination unit 41, the stuck-ON determination unit 42 determines that the set temperature UP switch 11a is in a stuck-ON state. A value of the predetermined time is not limited to 5 seconds. Also when an ON signal is continuously output from another switch for the predetermined time, the stuck-ON determination unit 42 determines that the switch that outputs the ON signal is in a stuck-ON state. Information about a result of the determination made by the stuck-ON determination unit 42 is output to the storage unit 43, the stuck-ON recognition unit 45, and the default set value command unit 46. In addition, when the vehicle is brought to the next trip by IG-ON after IG-OFF, and an OFF signal is input to the operation status determination unit 41 from the switch that has been determined to be in a stuck-ON state, the stuck-ON determination unit 42 cancels the determination that the switch is in the stuck-ON state.

The storage unit 43 stores previous set values for air-conditioning control and information about the switch being stuck ON. Storing the previous set values for air-conditioning control refers to storing, even when IG-OFF is performed while the air conditioner unit 3 is operating during IG-ON of the vehicle, information about a set air volume and a set temperature immediately before the IG-OFF. In addition, storing information about the switch being stuck ON refers to storing, when the stuck-ON determination unit 42 determines that there is a switch that is in a stuck-ON state during IG-ON of the vehicle, information that the switch is in the stuck-ON state even after IG-OFF. These pieces of information are kept stored also when the next trip of the vehicle is started by IG-ON after IG-OFF.

An ON signal and an OFF signal of the IG switch 51 are input to the IG detection unit 44, and the IG detection unit 44 outputs information of the signals to the default set value command unit 46.

The stuck-ON recognition unit 45 is a functional unit that recognizes (sets), as being in a stuck-ON state, the switch (the other one of the first switch and the second switch in the present disclosure) that provides, to a device or a unit that is the control target of the switch (one of the first switch and the second switch in the present disclosure) that has been determined to be in a stuck-ON state and operation of which has been disabled by the stuck-ON determination unit 42, a control instruction different from an instruction from the switch (the switch that has been determined to be in the stuck-ON state). In other words, when the switch (the other one of the switches in the present disclosure) is not in a stuck-ON state, but the switch (one of the switches in the present disclosure) that provides, to a device or a unit that is the control target of the other switch, a control instruction different from an instruction from the other switch is in a stuck-ON state and its operation is disabled, the switch that is not in a stuck-ON state is also recognized as being in a stuck-ON state. For example, when it is determined that the set temperature UP switch 11a of the driver's seat side set temperature change switch 11 is in a stuck-ON state, the set temperature DOWN switch 11b is recognized as being in a stuck-ON state, and operation of the set temperature DOWN switch 11b is disabled. For example, when it is determined that the air volume increase switch 14b is in a stuck-ON state, the air volume decrease switch 14c is recognized as being in a stuck-ON state, and operation of the air volume decrease switch 14c is disabled. This makes it possible to avoid a situation in which, when one of the switches that provide different control instructions to the same control target becomes stuck ON, a return from control in one direction performed by a depression operation on the switch that is not in a stuck-ON state to control in the other direction cannot be made.

The default set value command unit 46 can receive signals from the stuck-ON determination unit 42 and the IG detection unit 44. When the stuck-ON determination unit 42 determines that a certain switch is in a stuck-ON state while an IG-ON state is maintained, a default set value command signal is transmitted as a command signal to the device (control target) that is the target of the switch (the switch being in the stuck-ON state). For example, the default set value is, for example, zero for the volume of air blown by the fan 32 and 25° C. for the set temperature of the air-conditioning air in the heat pump 31. That is, when the air volume increase switch 14b or the air volume decrease switch 14c becomes stuck ON, the volume of air blown by the fan 32 is set to zero (the fan 32 is stopped). In addition, when the set temperature UP switch 11a or the set temperature DOWN switch 11b of the driver's seat side set temperature change switch 11 becomes stuck ON, the driver's seat side set temperature is set to 25° C. Similarly, when the set temperature UP switch 18a or the set temperature DOWN switch 18b of the front passenger seat side set temperature change switch 18 becomes stuck ON, the front passenger seat side set temperature is set to 25° C. Although these values can be set to any values, these values are preferably values that can achieve a significant reduction in power consumption.

In addition, also when the next trip is started by IG-ON after IG-OFF in a state in which information that a certain switch is in a stuck-ON state is stored in the storage unit 43, the default set value command unit 46 is configured to transmit a default set value command signal to the air conditioner unit 3 as a command signal to the device that is the target of the switch (the switch in a stuck-ON state). That is, also at IG-ON in a situation in which a certain switch is in a stuck-ON state, the device that is the target of the switch (the switch in the stuck-ON state) is controlled using the default set value.

Due to such a system configuration, the functional units described above in the air conditioner operation portion 1 and the air conditioner ECU 4 constitute the switch system according to the present disclosure.

### Air-Conditioning Control

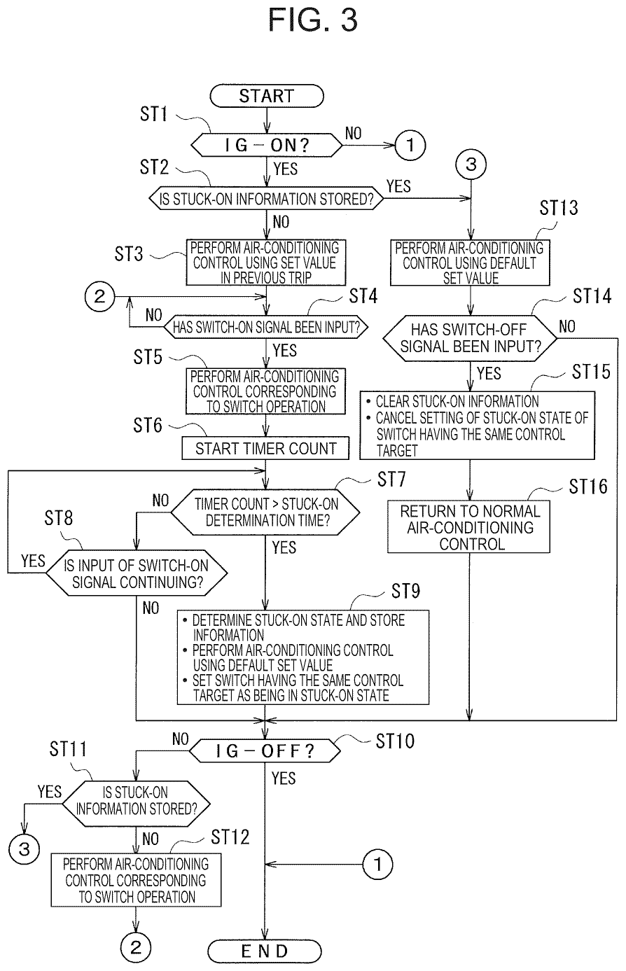

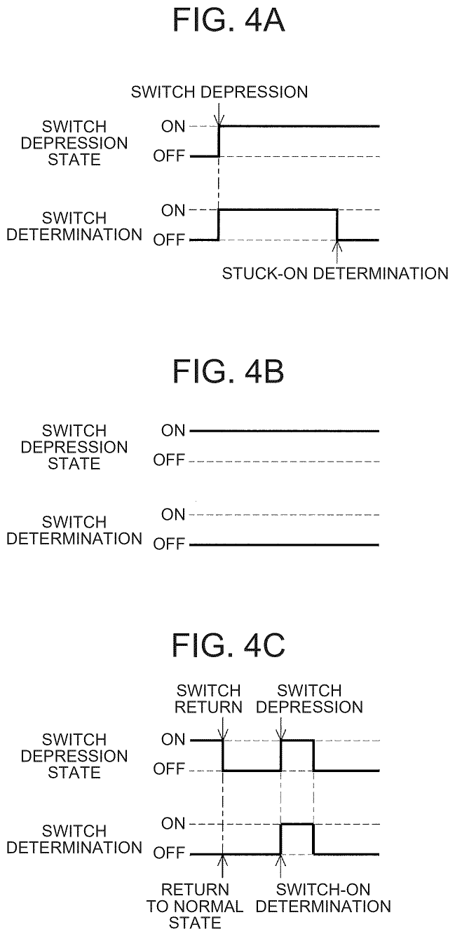

Next, air-conditioning control when a switch operation is performed in the configuration described above will be described with reference to FIGS. 3, 4A, 4B, and 4C. FIG. 3 is a flowchart showing the procedure for air-conditioning control in response to a switch operation in the present embodiment. FIGS. 4A, 4B, and 4C are timing charts showing the relationship between a switch depression state and switch determination corresponding thereto. In the following, one of the switches 11 to 18 (e.g., the driver's seat side set temperature change switch 11) will be described as an example.

First, in step ST1, it is determined whether IG-ON has been performed (whether the IG detection unit 44 has received an ON signal from the IG switch 51). When IG-ON is not performed and a NO determination is thus made in step ST1, the process is finished.

On the other hand, when IG-ON has been performed and a YES determination is thus made in step ST1, the process shifts to step ST2 to determine whether stuck-ON information is stored in the storage unit 43. When there is no switch that is in a stuck-ON state and no stuck-ON information is stored in the storage unit 43, a NO determination is made in step ST2, and the process shifts to step ST3. In step ST3, air-conditioning control using the previous set values (the set air volume and the set temperature in the previous trip) of air-conditioning control stored in the storage unit 43 is started, and the process shifts to step ST4.

In step ST4, it is determined whether an ON signal (a switch-ON signal) has been input (input to the operation status determination unit 41) from a certain switch (e.g., the set temperature UP switch 11a of the driver's seat side set temperature change switch 11) in response to the switch being operated to be depressed.

When a YES determination is made in step ST4 due to the input of the ON signal from the switch, the process shifts to step ST5, and air-conditioning control corresponding to the switch operation is performed. For example, when the set temperature UP switch 11a of the driver's seat side set temperature change switch 11 is operated to be depressed, the driver's seat side set temperature is raised by one level (e.g., 0.5° C.). In this case, when the switch is held down, air-conditioning control corresponding to the operation is performed every predetermined time. For example, when the set temperature UP switch 11a of the driver's seat side set temperature change switch 11 is held down, the driver's seat side set temperature is raised by one level every predetermined time.

When the air-conditioning control corresponding to the switch operation is started in this manner, a timer provided in the air conditioner ECU 4 starts counting in step ST6, and the process shifts to step ST7. In step ST7, it is determined whether the count of the timer exceeds a predetermined stuck-ON determination time. That is, it is determined whether the ON signal from the switch is continuously input for the predetermined time. The stuck-ON determination time can be set to any time.

When the count of the timer does not exceed the predetermine stuck-ON determination time and a NO determination is thus made in step ST7, the process shifts to step ST8 to determine whether the input of the ON signal from the switch is continuing. When the input of the ON signal from the switch is stopped, a NO determination is made in step ST8, and the process shifts to step ST10. On the other hand, the input of the ON signal from the switch is continuing, a YES determination is made in step ST8, and the process returns to step ST7.

When the input of the ON signal from the switch is not stopped, and the time for which the ON signal is continuously input (the count of the timer) exceeds the stuck-ON determination time, a YES determination is made in step ST7, and the process shifts to step ST9. In step ST9, the stuck-ON determination unit 42 determines that the switch is in a stuck-ON state and stuck-ON information is stored in the storage unit 43, and the default set value command unit 46 transmits the default set value command signal to the air conditioner unit 3. FIG. 4A shows the relationship between the switch depression state and switch determination corresponding thereto at this time. That is, since the duration of the switch depression state exceeds the predetermined time (stuck-ON determination time), it is determined that the switch is in a stuck-ON state as the switch determination. When it is determined that the switch is in the stuck-ON state in this manner, air-conditioning control using the default set value is performed. For example, when it is determined that the set temperature UP switch 11a of the driver's seat side set temperature change switch 11 is in a stuck-ON state, the driver's seat side set temperature is set to 25° C. For example, when it is determined that the air volume increase switch 14b is in a stuck-ON state, the volume of air blown by the fan 32 is set to zero (the fan 32 is stopped).

As a feature of the present embodiment, in step ST9, the switch that provides, to a device that is the control target of the switch determined to be in a stuck-ON state by the stuck-ON determination unit 42, a control instruction different from an instruction from the switch determined to be in the stuck-ON state is recognized as being in a stuck-ON state. For example, when it is determined that the set temperature UP switch 11a of the driver's seat side set temperature change switch 11 is in a stuck-ON state, the set temperature DOWN switch 11b is recognized as being in a stuck-ON state, and operation of the set temperature DOWN switch 11b is disabled. For example, when it is determined that the air volume increase switch 14b is in a stuck-ON state, the air volume decrease switch 14c is recognized as being in a stuck-ON state, and operation of the air volume decrease switch 14c is disabled. After the air-conditioning control using the default set value described above is started with both the switches that provide different control instructions to the same control target treated as being in the stuck-ON state (with their operation disabled) in this manner, the process shifts to step ST10.

In step ST10, it is determined whether IG-OFF has been performed (whether the IG detection unit 44 has received an OFF signal from the IG switch 51). When IG-OFF has been performed and a YES determination is thus made in step ST10, the air-conditioning control is stopped to finish the control. On the other hand, when IG-OFF has not been performed (the IG-ON state is maintained) and a NO determination is thus made in step ST10, the process shifts to step ST11 to determine whether stuck-ON information is stored in the storage unit 43. That is, it is determined whether a YES determination is made (the switch is determined to be in a stuck-ON state) in step ST7 and the stuck-ON information is stored in the storage unit 43 in step ST9. When the stuck-ON information is not stored in the storage unit 43 and a NO determination is thus made in step ST11, the process shifts to step ST12 to perform air-conditioning control corresponding to the switch operation. On the other hand, when the stuck-ON information is stored in the storage unit 43 and a YES determination is thus made in step ST11, the process shifts to step ST13.

In step ST13, air-conditioning control using the default set value based on the default set value command signal transmitted from the default set value command unit 46 to the air conditioner unit 3 is performed (when air-conditioning control using the default set value is performed in step ST9, the air-conditioning control is continued). Then, in step ST14, it is determined whether an OFF signal (switch-OFF signal) has been input (input to the operation status determination unit 41) from the switch that has been determined to be in the stuck-ON state.

When an OFF signal has not been input to the operation status determination unit 41 from the switch determined to be in the stuck-ON state and a NO determination is thus made in step ST14, the process returns to step ST10. On the other hand, when an OFF signal has been input to the operation status determination unit 41 from the switch determined to be in the stuck-ON state and a YES determination is thus made in step ST14, the process shifts to step ST15 to clear the stuck-ON information stored in the storage unit 43. That is, since the switch that has been in the stuck-ON state returns to its original position, the stuck-ON information is cleared. In addition, along with this, the recognition of the stuck-ON state of the switch recognized as being in the stuck-ON state in step ST9 is canceled, and operation of the switch is enabled. For example, when, in step ST9, it is determined that the set temperature UP switch 11a of the driver's seat side set temperature change switch 11 is in a stuck-ON state and the set temperature DOWN switch 11b is accordingly recognized as being in a stuck-ON state, in response to the stuck-ON state of the set temperature UP switch 11a being resolved and an OFF signal being output, the recognition of the stuck-ON state of the set temperature DOWN switch 11b is canceled, and operation of the switch is enabled. In addition, when, in step ST9, it is determined that the air volume increase switch 14b is in a stuck-ON state and the air volume decrease switch 14c is accordingly recognized as being in a stuck-ON state, in response to the stuck-ON state of the air volume increase switch 14b being resolved and an OFF signal being output, the recognition of the stuck-ON state of the air volume decrease switch 14c is canceled, and operation of the switch is enabled.

Then, the process shifts to step ST16 and returns to normal air-conditioning control corresponding to the switch operation.

When IG-OFF is performed in step ST10 while the state in which it is determined that the switch is in a stuck-ON state and the stuck-ON information is stored in the storage unit 43 in step ST9 is maintained, in the next trip (next routine) caused by the following IG-ON, a YES determination is made in step ST1 and a YES determination is made in step ST2, and the default set value command unit 46 transmits a default set value command signal to the air conditioner unit 3. Accordingly, air-conditioning control using the default set value based on the default set value command signal is performed on the control target of the switch in the stuck-ON state. Then, in step ST14, when an OFF signal has not been input to the operation status determination unit 41 from the switch determined to be in the stuck-ON state, the process shifts to step ST10. FIG. 4B shows the relationship between the switch depression state and the switch determination corresponding thereto at this time. That is, since the switch is in the stuck-ON state, the switch depression state is maintained. On the other hand, since being in the stuck-ON state is stored, the switch determination is OFF (a state in which the switch operation is not accepted).

In addition, when an OFF signal has been input to the operation status determination unit 41 from the switch that has been determined to be in the stuck-ON state, the stuck-ON information stored in the storage unit 43 is cleared in step ST15. That is, since the switch in the stuck-ON state returns to its original position, the stuck-ON information is cleared. In addition, along with this, in the same manner as above, the recognition of the stuck-ON state of the switch recognized as being in the stuck-ON state in step ST9 is canceled, and operation of the switch is enabled. Then, the process shifts to step ST16 and returns to the normal air-conditioning control corresponding to the switch operation. FIG. 4C shows the relationship between the switch depression state and the switch determination corresponding thereto at this time. That is, since the switch returns to its original position, it is determined in the switch determination that the switch has returned to a normal state. When the switch is depressed thereafter, it is accordingly determined in the switch determination that the switch has been turned ON. The above operation is repeated.

### Effects of Embodiment

As described above, in the present embodiment, when it is determined that one of the switches that provide different control instructions to the same control target is in a stuck-ON state, the other one of the switches is also set as being in a stuck-ON state. Thus, it is possible to avoid a situation in which, when it is determined that only one of the switches is in a stuck-ON state, operation on the other one of the switches is enabled, and a return from control in a direction corresponding to the operation on the other switch to control in the other direction cannot be made. That is, it is possible to eliminate the malfunction caused by only one of the switches becoming stuck ON.

### Modifications of Switch

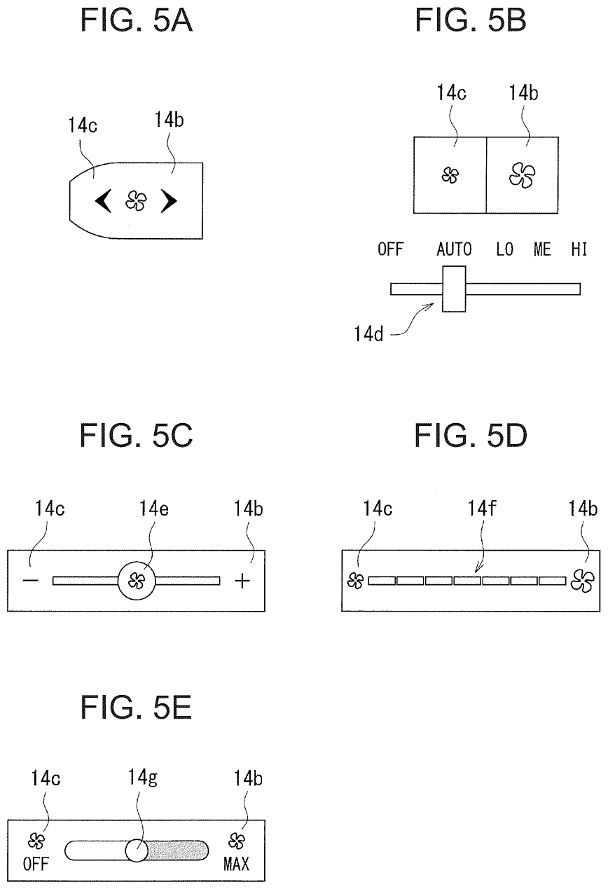

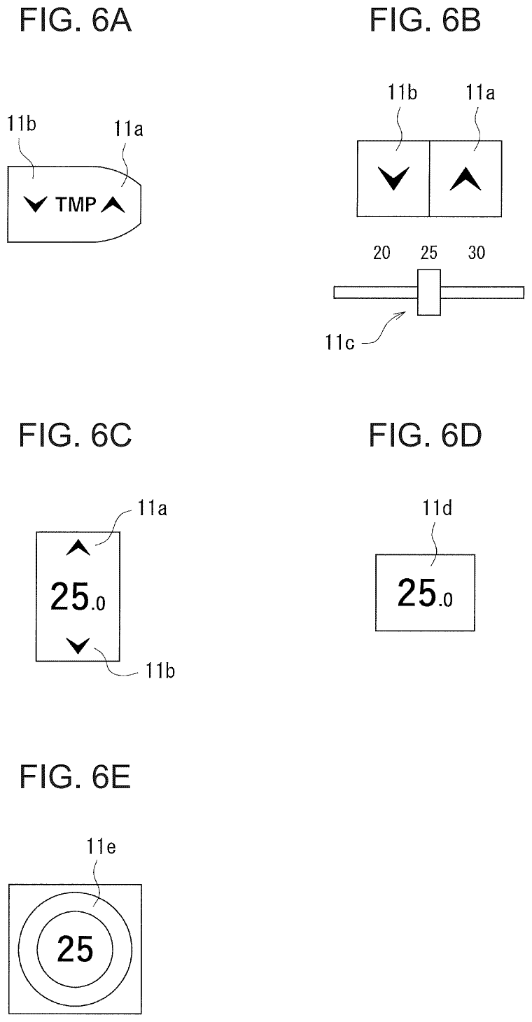

Next, a plurality of modifications of the switch will be described. FIGS. 5A, 5B, 5C, 5D, and 5E are diagrams showing a plurality of modifications of the air volume setting switch. FIGS. 6A, 6B, 6C, 6D, and 6E are diagrams showing a plurality of modifications of the set temperature change switch.

FIG. 5A shows a physical switch including the air volume increase switch 14b disposed on the right side and the air volume decrease switch 14c disposed on the left side.

FIG. 5B shows a configuration in which the air volume increase switch 14b configured as a physical switch is disposed on the right side, the air volume decrease switch 14c configured as a physical switch is disposed on the left side, and a single-action selection switch 14d that enables setting of the air volume by operating a lever is disposed under the air volume increase switch 14b and the air volume decrease switch 14c.

FIG. 5C shows a touch panel switch including the air volume increase switch 14b disposed on the right side, the air volume decrease switch 14c disposed on the left side, and a single-action selection switch disposed between the switches 14b, 14c. The single-action selection switch enables the set air volume to be increased or reduced by pressing a fan mark 14e displayed as an image with a finger and moving the finger in the right-left direction.

FIG. 5D shows a touch panel switch including the air volume increase switch 14b disposed on the right side, the air volume decrease switch 14c disposed on the left side, and a single-action selection switch disposed between the switches 14b, 14c. The single-action selection switch enables setting of the air volume by pressing any position of an indicator 14f displayed as an image with a finger.

FIG. 5E shows a touch panel switch similar to that shown in FIG. 5C, the touch panel switch including the air volume increase switch 14b disposed on the right side, the air volume decrease switch 14c disposed on the left side, and a single-action selection switch disposed between the switches 14b, 14c. The single-action selection switch enables the set air volume to be increased or reduced by pressing a circular mark 14g displayed as an image with a finger and moving the finger in the right-left direction.

In the case of the switches shown in FIGS. 5B to 5E, when it is determined that only one of the air volume increase switch 14b and the air volume decrease switch 14c is in a stuck-ON state, the operation of the switches 14b, 14c is disabled, and control instructions to the fan 32 thus cannot be provided by operating the switches 14b, 14c. However, since the single-action selection switch (the third switch in the present disclosure) that can provide an instruction to increase or reduce the air volume of the fan 32 is provided in addition to the switches 14b, 14c, the single-action selection switch is not set as being in a stuck-ON state. That is, operation of the single-action selection switch is enabled. Accordingly, even when only one of the air volume increase switch 14b and the air volume decrease switch 14c becomes stuck ON, it is possible to provide an instruction to increase or reduce the air volume of the fan 32 and continuously control the fan 32. When it is determined that only one of the air volume increase switch 14b and the air volume decrease switch 14c is in a stuck-ON state, not only the other one of the switches is recognized as being in a stuck-ON state, but also the single-action selection switch may be recognized as being in a stuck-ON state.

FIG. 6A shows a physical switch including the set temperature UP switch 11a disposed on the right side, and the set temperature DOWN switch 11b disposed on the left side.

FIG. 6B shows a configuration in which the set temperature UP switch 11a configured as a physical switch is disposed on the right side, the set temperature DOWN switch 11b configured as a physical switch is disposed on the left side, and a direct instruction switch 11c that enables the set temperature to be changed by operating a lever is disposed under the set temperature UP switch 11a and the set temperature DOWN switch 11b.

FIG. 6C shows a touch panel switch having a configuration in which the set temperature UP switch 11a is disposed on the upper side, and the set temperature DOWN switch 11b is disposed on the lower side.

FIG. 6D shows a touch panel switch that is a direct instruction switch that enables the set temperature to be changed by sliding a finger put on a display screen 11d showing the current set temperature in the right-left direction (a swipe operation).

FIG. 6E shows a touch panel switch that is a direct instruction switch that enables the set temperature to be changed by moving a finger put on an operation ring 11e around a display screen showing the current set temperature in the circumferential direction. In addition, the function of changing the changeable range of the set temperature in accordance with the moving speed of the finger (relative instruction switch function) is also provided.

In the case of the switches shown in FIGS. 6B, 6D, and 6E, when it is determined that only one of the set temperature UP switch 11a and the set temperature DOWN switch 11b is in a stuck-ON state, the operation of the switches 11a, 11b is disabled, and control instructions to the heat pump 31 thus cannot be provided by operating the switches 11a, 11b. However, since the direct instruction switch or the relative instruction switch (the third switch in the present disclosure) that can provide an instruction to raise or lower the set temperature of the heat pump 31 is provided in addition to the switches 11a, 11b, the direct instruction switch or the relative instruction switch is not set as being in a stuck-ON state. That is, operation of the direct instruction switch or the relative instruction switch is enabled. Accordingly, even when only one of the set temperature UP switch 11a and the set temperature DOWN switch 11b becomes stuck ON, it is possible to provide an instruction to raise or lower the set temperature of the heat pump 31 and continuously control the heat pump 31. When it is determined that only one of the set temperature UP switch 11a and the set temperature DOWN switch 11b is in a stuck-ON state, not only the other one of the switches is recognized as being in a stuck-ON state, but also the direct instruction switch or the relative instruction switch may be recognized as being in a stuck-ON state.

### Other Embodiments

The present disclosure is not limited to the embodiment and modifications described above, and all modifications and applications that are included in the scope of the claims and the scope equivalent thereto can be made.

For example, in the above description of the embodiment and modifications, the present disclosure is applied to the switch system including the switches 11 to 18 (the switches on the air conditioner operation portion 1 for the front seat) for operating the air conditioner (air conditioner unit 3) of the vehicle (battery electric vehicle). The present disclosure is not limited thereto, and also applicable to switch systems provided in various apparatuses. For example, the present disclosure is applicable to a switch system including each switch on an air conditioner operation portion for the rear seat in which a control instruction can be provided independently of each switch of the air conditioner operation portion 1 for the front seat (a case in which a single operation can be made), or applicable to a switch system for a seat heater that can be adjusted in temperature.

In the embodiment (FIG. 1), the case in which the switches 11 to 18 are physical switches that output an ON signal when operated to be depressed and output an OFF signal when the depression operation is released is described as an example. The present disclosure is not limited thereto, and may include a switch that outputs OV when not operated and outputs a predetermined voltage (e.g., 5V) when operated. In addition, a switch having the function of determining a stuck-ON state may be provided. In this case, the operation status determination unit 41 and the stuck-ON determination unit 42 described above are provided in the switch.

In the embodiment and modifications described above, when it is determined that the switch is in a stuck-ON state, the default set value command signal is transmitted as a command signal to the target device of the switch. The application of the present disclosure is not limited to the air conditioner unit that transmits such a default set value command signal.

The present disclosure is applicable to control performed when a switch in a switch system for operating an air conditioner of a vehicle becomes stuck ON.

What is claimed is:

1. A switch system comprising:
a first switch that provides a control instruction to a control target by being operated; and
a second switch that provides a control instruction different from the control instruction from the first switch to the control target by being operated, wherein
when determination is made that only one of the first switch and the second switch is in a stuck-ON state, and operation of the switch in the stuck-ON state is disabled, the other one of the first switch and the second switch is also set as being in a stuck-ON state.

2. The switch system according to claim 1, wherein when determination is made that the stuck-ON state of the one of the first switch and the second switch determined to be in the stuck-ON state is resolved, the setting of the other one of the first switch and the second switch as being in the stuck-ON state is canceled.

3. The switch system according to claim 1, wherein the first switch and the second switch indicate directions of control in the control target, and the direction of the control instruction from the first switch and the direction of the control instruction from the second switch are opposite to each other.

4. The switch system according to claim 3, further comprising
a third switch that selectively provides control instructions in both the direction of the control in the control target when the first switch is operated and the direction of the control in the control target when the second switch is operated, wherein
when determination is made that only one of the first switch and the second switch is in a stuck-ON state, and operation of the switch in the stuck-ON state is disabled, the other one of the first switch and the second switch is also set as being in a stuck-ON state, whereas operation of the third switch is enabled without setting the third switch as being in a stuck-ON state.
